(19) United States
(12) Patent Application Publication
(10) Pub. No.: US 2019/0043074 A1
(43) Pub. Date: Feb. 7, 2019

(54) SYSTEMS AND METHODS FOR PROVIDING MACHINE LEARNING BASED RECOMMENDATIONS ASSOCIATED WITH IMPROVING QUALITATIVE RATINGS

(71) Applicant: Facebook, Inc., Menlo Park, CA (US)

(72) Inventors: Alexander Peysakhovich, San Francisco, CA (US); Michael Randolph Corey, New York (CA); Hannah Siow Pavalow, Brooklyn, NY (US)

(21) Appl. No.: 15/668,447

(22) Filed: Aug. 3, 2017

(51) Int. Cl. G06Q 30/02; G06N 99/00

(52) U.S. Cl. CPC G06Q 30/0243; G06N 99/005; G06Q 30/0244

(57) ABSTRACT

Systems, methods, and non-transitory computer readable media can predict one or more qualitative ratings associated with an advertisement based on a machine learning model. One or more advertisements that are visually similar to the advertisement can be identified. At least one difference between the advertisement and the one or more advertisements can be determined. A recommendation for improving the one or more qualitative ratings associated with the advertisement can be provided based on the at least one difference.

### CROSS-REFERENCE TO RELATED APPLICATIONS

This application is related to U.S. patent application Ser. No. ______, filed on Aug. 3, 2017 and entitled “SYSTEMS AND METHODS FOR PREDICTING QUALITATIVE RATINGS FOR ADVERTISEMENTS BASED ON MACHINE LEARNING” (Attorney Docket No.: 36FB-180518), U.S. patent application Ser. No. ______, filed on Aug. 3, 2017 and entitled “SYSTEMS AND METHODS FOR DETERMINING VISUALLY SIMILAR ADVERTISEMENTS FOR IMPROVING QUALITATIVE RATINGS ASSOCIATED WITH ADVERTISEMENTS” (Attorney Docket No.: 36FB-180535), and U.S. patent application Ser. No. ______, filed on Aug. 3, 2017 and entitled “SYSTEMS AND METHODS FOR PROVIDING APPLICATIONS ASSOCIATED WITH IMPROVING QUALITATIVE RATINGS BASED ON MACHINE LEARNING” (Attorney Docket No.: 36FB-180537), each of which is incorporated herein by reference in its entirety.

### FIELD OF THE INVENTION

The present technology relates to the field of social networks. More particularly, the present technology relates to machine learning techniques for generating optimized content, such as advertisements, associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access. In some cases, a social networking system may also provide advertisements from various entities. For example, one or more advertisements can be presented through a feed for a user.

### SUMMARY

Various embodiments of the present disclosure can include systems, methods, and non-transitory computer readable media configured to predict one or more qualitative ratings associated with an advertisement based on a machine learning model. One or more advertisements that are visually similar to the advertisement can be identified. At least one difference between the advertisement and the one or more advertisements can be determined. A recommendation for improving the one or more qualitative ratings associated with the advertisement can be provided based on the at least one difference.

In some embodiments, a representation of each advertisement includes a feature vector including a set of features.

In certain embodiments, the determining the at least one difference between the advertisement and the one or more advertisements includes identifying one or more features in the set of features for which values associated with the advertisement and values associated with the one or more advertisements are different.

In an embodiment, a difference between the values of the advertisements and the values of the one or more advertisements satisfies one or more of a threshold value or a threshold range.

In some embodiments, the recommendation for improving the one or more qualitative ratings is based on the identified one or more features.

In certain embodiments, the at least one difference relates to one or more of: presence of an element, absence of an element, an arrangement of one or more elements, or characteristics associated with one or more elements.

In an embodiment, the one or more qualitative ratings relate to one or more of: noticeability, a focal point, interesting information, an emotional reward, or a call-to-action (CTA).

In some embodiments, a template for the advertisement can be determined, wherein the template is visually similar to the advertisement.

In certain embodiments, values of qualitative ratings associated with the one or more advertisements are higher than values of the one or more qualitative ratings associated with the advertisement.

In an embodiment, the one or more advertisements are associated with a cluster of advertisements with which the advertisement is associated.

Various embodiments of the present disclosure can include systems, methods, and non-transitory computer readable media configured to obtain an advertisement via a user interface associated with an application. One or more qualitative ratings associated with the advertisement can be predicted based on a machine learning model. One or more recommendations for improving the qualitative ratings associated with the advertisement can be provided, via the user interface, based at least in part on one or more advertisements that are visually similar to the advertisement.

In some embodiments, the user interface is associated with one or more of: capturing an image of the advertisement or uploading the advertisement.

In certain embodiments, the application includes one or more of: a chat application, a messaging application, a social networking application, or a page manager application.

In an embodiment, the application is a chat application or a messaging application, and the obtaining the advertisement and the providing the one or more recommendations are performed by an automated agent in a chat conversation.

In some embodiments, the application is a page manager application, and the obtaining the advertisement and the providing the one or more recommendations in a chat conversation are performed on a page associated with an entity.

In certain embodiments, a workflow for providing the one or more recommendations is initiated in response to selection of a user interface (UI) element in the user interface.

In an embodiment, the one or more qualitative ratings relate to one or more of: noticeability, a focal point, interesting information, an emotional reward, or a call-to-action (CTA).

In some embodiments, values of qualitative ratings associated with the one or more advertisements are higher than values of the one or more qualitative ratings associated with the advertisement.

In certain embodiments, a template for the advertisement can be determined, wherein the template is visually similar to the advertisement.

In an embodiment, the one or more advertisements are associated with a cluster of advertisements with which the advertisement is associated.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example advertisement recommendation module configured to provide recommendations for improving qualitative ratings of advertisements, according to an embodiment of the present disclosure.

FIG. 2 illustrates an example recommendation module configured to provide recommendations for improving qualitative ratings of advertisements based on visually similar advertisements, according to an embodiment of the present disclosure.

FIG. 3A illustrates an example scenario for providing recommendations for improving qualitative ratings of advertisements, according to an embodiment of the present disclosure.

FIG. 3B illustrates an example user interface for providing recommendations for improving qualitative ratings of advertisements, according to an embodiment of the present disclosure.

FIG. 3C illustrates an example user interface for providing recommendations for improving qualitative ratings of advertisements, according to an embodiment of the present disclosure.

FIG. 4 illustrates an example first method for providing recommendations for improving qualitative ratings of advertisements, according to an embodiment of the present disclosure.

FIG. 5 illustrates an example second method for providing recommendations for improving qualitative ratings of advertisements, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Improving Qualitative Ratings for Advertisements

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access.

A social networking system may also provide advertisements from various entities. For example, one or more advertisements can be presented through a feed for a user. Entities associated with (e.g., creating, publishing, sponsoring) advertisements may be interested in finding out whether their advertisements presented in various channels of the social networking system are effective according to various criteria. Under conventional approaches specifically arising in the realm of computer technology, entities associated with advertisements can request human reviewers to rate their advertisements as presented through the social networking system according to various criteria. However, obtaining ratings for such advertisements from human reviewers can require significant amounts of time and resources, especially when an aggregate volume of advertisements, such as advertisement volume on a social networking system, is large.

An improved approach rooted in computer technology can overcome the foregoing and other disadvantages associated with conventional approaches specifically arising in the realm of computer technology. Based on computer technology, the disclosed technology can automatically determine qualitative ratings for advertisements based on machine learning techniques. The disclosed technology can also identify visually similar advertisements for advertisements. The disclosed technology can provide recommendations for improving qualitative ratings for the advertisements based on the visually similar advertisements. Qualitative ratings can relate to various criteria associated with advertisements, such as noticeability, a focal point, interesting information, emotional reward, and call-to-action (CTA). Advertisements can be clustered based on respective representations (e.g., feature vectors) of the advertisements. For a particular advertisement, one or more visually similar advertisements can be identified based on a cluster associated with the particular advertisement. As an example, visually similar advertisements that have higher values of one or more qualitative ratings than the particular advertisement can be identified. Recommendations to improve qualitative ratings for the particular advertisement can be provided based on visually similar advertisements for the particular advertisement. In some embodiments, recommendations to improve qualitative ratings associated with advertisements can be provided in an application, such as a social networking application. In this way, the disclosed technology can automatically predict qualitative ratings for advertisements as well as provide recommendations for improving qualitative ratings based on visually similar advertisements that have high qualitative ratings. Details relating to the disclosed technology are provided below.

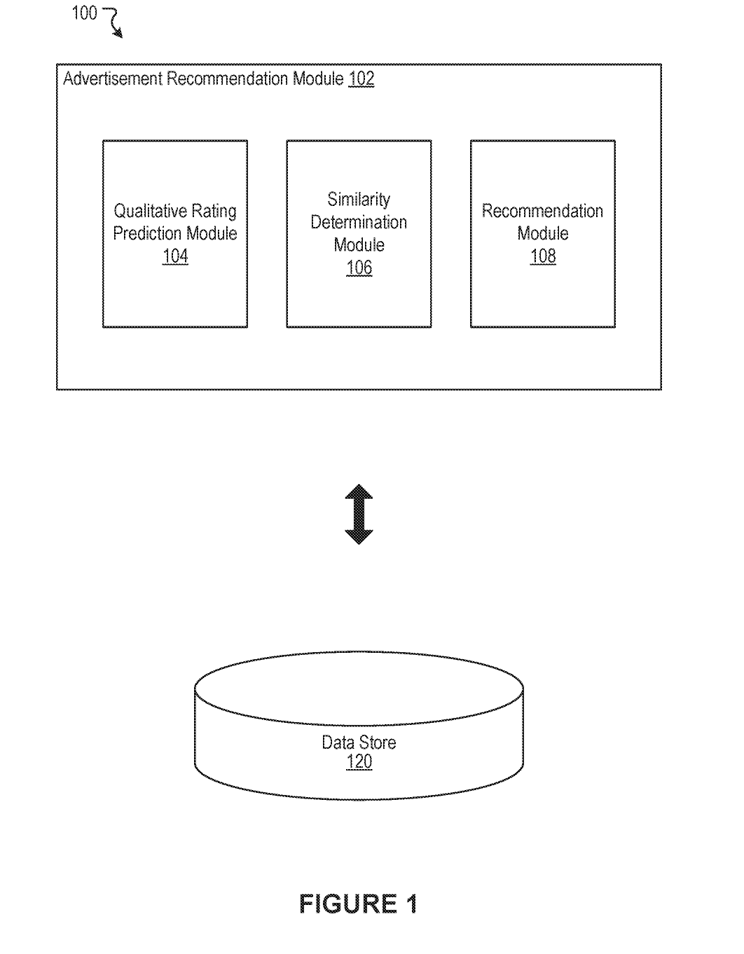

FIG. 1 illustrates an example system 100 including an example advertisement recommendation module 102 configured to provide recommendations for improving qualitative ratings of advertisements, according to an embodiment of the present disclosure. The example advertisement recommendation module 102 can include a qualitative rating prediction module 104, a similarity determination module 106, and a recommendation module 108. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the advertisement recommendation module 102 can be implemented in any suitable combinations. While the disclosed technology is described in connection with advertisements associated with a social networking system for illustrative purposes, the disclosed technology can apply to any other type of system and/or content.

The qualitative rating prediction module 104 can predict qualitative ratings for advertisements based on machine learning techniques. Qualitative ratings can relate to various criteria associated with advertisements. In some embodiments, criteria can be based at least in part on visual content of advertisements. Examples of qualitative ratings can include noticeability, a focal point, interesting information, emotional reward, and call-to-action. The noticeability qualitative rating can indicate whether or an extent to which an advertisement captures attention. The focal point qualitative rating can indicate whether or an extent to which an advertisement has a focal point. The interesting information qualitative rating can indicate whether or an extent to which an advertisement includes interesting information. The emotional reward qualitative rating can indicate whether or an extent to which an advertisement appeals emotionally. The call-to-action qualitative rating can indicate whether or an extent to which an advertisement includes a CTA. Many variations in the criteria for qualitative ratings are possible.

An advertisement can be represented as a set of features (e.g., a feature vector). Advertisements can be in any format, such as images, videos, audio, etc. Each feature included in a representation of an advertisement can be associated with an attribute for an advertisement, such as a visual attribute or a nonvisual attribute. Examples of visual attributes can include whether an advertisement depicts a particular object, a particular concept, a particular theme, a particular animal, a particular person or people in general, etc. Examples of nonvisual attributes may include metadata for advertisements or other information associated with advertisements. A value for a feature can indicate a likelihood of an advertisement being associated with a corresponding attribute. In certain embodiments, each feature can indicate whether an advertisement is associated with a particular category. For example, a category can relate to an object, a concept, a theme, an animal, one or more people, etc. A number of features included in the set of features can be selected as appropriate. As just one example, the set of features can include 2,048 features. In other implementations, the set of features can include a different number of features. In certain embodiments, values for different features can be normalized such that the values can be compared across features. In some embodiments, representations of advertisements can be determined based on machine learning techniques, such as machine vision or computer vision techniques. For example, a machine learning model can be trained to determine representations of advertisements based on training data. The training data can include, for example, pixel data for advertisements and labels corresponding to various attributes associated with the advertisements. In certain embodiments, the machine learning model can include a neural network, such as a deep neural network (DNN), a convolutional neural network (CNN), etc.

The qualitative rating prediction module 104 can train a machine learning model to predict qualitative ratings for advertisements. For example, a machine learning model can be trained based on training data (e.g., labeled data) including representations of advertisements and values of qualitative ratings associated with the advertisements. Various types of machine learning models can be used to predict qualitative ratings. For example, the machine learning model can be a regression model (e.g., linear, nonlinear, logistic, etc.), a random forest, a neural network (e.g., a multilayer perceptrons (MLP), a DNN, a CNN, etc.), etc. The training data for training the machine learning model can include various features. For example, the training data can include some or all of features in the set of features included in representations of advertisements. As explained above, each feature in the set of features included in a representation of an advertisement can relate to an attribute associated with the advertisement. The machine learning model can determine weights associated with various features used to train the machine learning model.

The qualitative rating prediction module 104 can apply the trained machine learning model to predict qualitative ratings associated with an advertisement. For example, a representation of an advertisement can be provided to the trained machine learning model, and the trained machine learning model can output values for one or more qualitative ratings for the advertisement. The trained machine learning model can output a value for each qualitative rating. For instance, for each advertisement, the trained machine learning model can output a value for the noticeability qualitative rating, a value for the focal point qualitative rating, a value for the interesting information qualitative rating, a value for the emotional reward qualitative rating, and a value for the CTA qualitative rating. A value for a qualitative rating can indicate a degree or extent of a characteristic or criterion associated with the qualitative rating. In some embodiments, a value can be selected from a range of values. For example, a value can be assigned on a scale of 0 to 1, on a scale of 1 to 10, etc. In other embodiments, a value can be selected from a set of predetermined options or values (e.g., high, medium, low, etc.). In certain embodiments, values for different qualitative ratings can be normalized such that the values can be compared across qualitative ratings. One or more machine learning models discussed herein, for example, in connection with the advertisement recommendation module 102, can be implemented separately or in combination, for example, as a single machine learning model, as multiple machine learning models, as one or more staged machine learning models, as one or more combined machine learning models, etc. All examples herein are provided for illustrative purposes, and there can be many variations and other possibilities.

The similarity determination module 106 can determine advertisements that are similar, such as visually similar, to an advertisement. For example, advertisements for which qualitative ratings have been predicted can be clustered based on representations of the advertisements. In some embodiments, a representation of an advertisement can include a set of features (e.g., a feature vector), and advertisements can be clustered based on values for the set of features. For instance, a feature vector for an advertisement includes n features, features vectors for advertisements can be plotted in a n-dimensional feature space. For example, if a representation of an advertisement includes 2,048 features, values for the 2,048 features for each advertisement can be plotted in a 2,048-dimensional feature space. In other implementations, feature vectors can be reduced before advertisements are plotted in an associated reduced feature space. One or more clusters can be generated based on the plotted feature vectors. Any generally known approach for clustering data can be used, such as k-means clustering. In general, the number of clusters generated by the clustering module 204 can vary depending on the implementation.

Advertisements associated with a cluster can be considered to be visually similar to each other. Each advertisement in a cluster can have associated qualitative ratings, for example, as determined by the qualitative rating prediction module 104, as described above. A cluster may include some advertisements that have relatively high values for one or more qualitative ratings and some advertisements that have relatively low values for one or more qualitative ratings. For example, a value for a qualitative rating can be considered to be high when the value satisfies a threshold value, a threshold range, etc. Similarly, a value for a qualitative rating can be considered to be low when the value does not satisfy a threshold value, a threshold range, etc.

In some embodiments, an advertisement may be submitted to a social networking system for a prediction of qualitative ratings associated with the advertisement. Qualitative ratings for the advertisement can be predicted, for example, by the qualitative rating prediction module 104, as described above. For example, a representation of the advertisement can be determined and provided to a machine learning model that can predict qualitative ratings for the advertisement. If the advertisement has low values for one or more qualitative ratings, the similarity determination module 106 can determine one or more visually similar advertisements that are in a cluster associated with the advertisement and that have high values for the one or more qualitative ratings. For example, the advertisement can be plotted in a feature space based on a set of features for the advertisement, and a cluster with which the advertisement is associated can be determined. Within the cluster associated with the advertisement, the similarity determination module 106 can identify one or more advertisements that have high values for those qualitative ratings for which the advertisement has low values. For example, the similarity determination module 106 can search for advertisements in the cluster that have high values. As another example, the similarity determination module 106 can search for advertisements that are nearest to the advertisement. All examples herein are provided for illustrative purposes, and there can be many variations and other possibilities.

The recommendation module 108 can provide recommendations for improving qualitative ratings of advertisements based on visually similar advertisements. For an advertisement with predicted low values of one or more qualitative ratings, visually similar advertisements having high values of the one or more qualitative ratings can be identified. The recommendation module 108 can identify differences in visual content between the advertisement and the identified visually similar advertisements. The recommendation module 108 can provide one or more recommendations for improving the qualitative ratings of the advertisement based at least in part on the identified differences in visual content. Functionality of the recommendation module 108 is described in more detail herein.

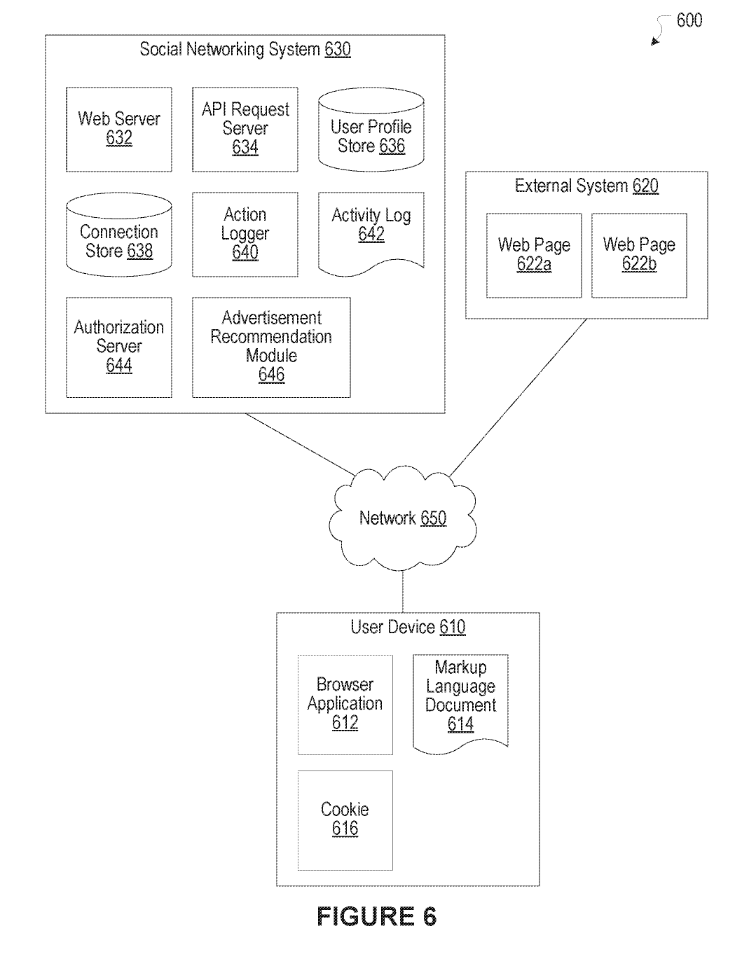

In some embodiments, the advertisement recommendation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the advertisement recommendation module 102 can be, in part or in whole, implemented as software running on one or more computing devices or systems, such as on a server system or a client computing device. In some instances, the advertisement recommendation module 102 can be, in part or in whole, implemented within or configured to operate in conjunction or be integrated with a social networking system (or service), such as a social networking system 630 of FIG. 6. Likewise, in some instances, the advertisement recommendation module 102 can be, in part or in whole, implemented within or configured to operate in conjunction or be integrated with a client computing device, such as the user device 610 of FIG. 6. For example, the advertisement recommendation module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the advertisement recommendation module 102. The data maintained by the data store 120 can include, for example, information relating to advertisements, representations of advertisements, qualitative ratings, machine learning models, features, features vectors, clusters, visually similar advertisements, recommendations, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the advertisement recommendation module 102 can be configured to communicate and/or operate with the data store 120. In some embodiments, the data store 120 can be a data store within a client computing device. In some embodiments, the data store 120 can be a data store of a server system in communication with the client computing device.

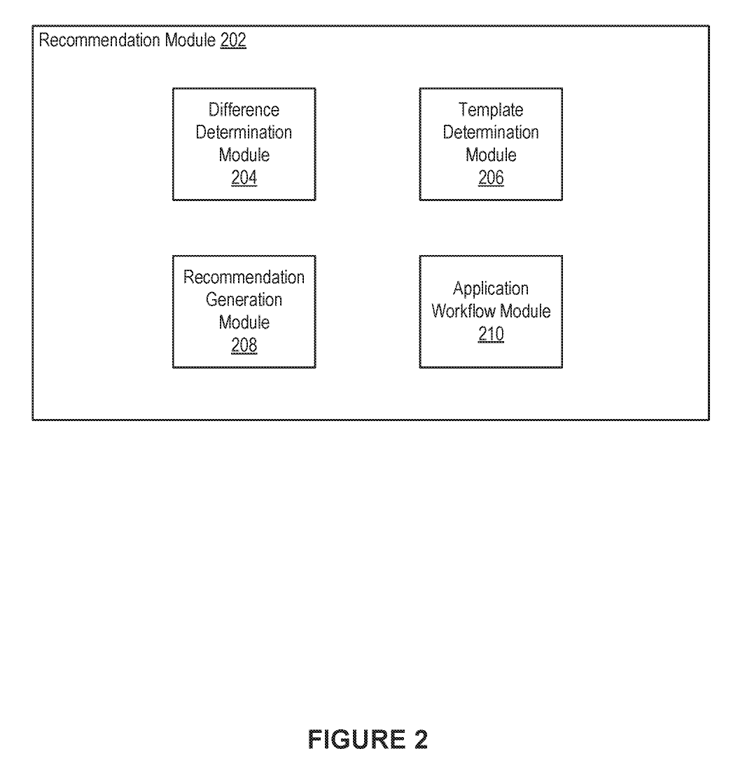

FIG. 2 illustrates an example recommendation module 202 configured to provide recommendations for improving qualitative ratings of advertisements based on visually similar advertisements, according to an embodiment of the present disclosure. In some embodiments, the recommendation module 108 of FIG. 1 can be implemented with the example recommendation module 202. As shown in the example of FIG. 2, the example recommendation module 202 can include a difference determination module 204, a template determination module 206, a recommendation generation module 208, and an application workflow module 210.

The difference determination module 204 can identify differences in content, such as visual content, between an advertisement and similar advertisements, such as visually similar advertisements. For example, for an advertisement with predicted low values of one or more qualitative ratings, visually similar advertisements having high values of the one or more qualitative ratings can be identified. Visually similar advertisements can be identified, for example, by the similarity determination module 106, as described above. The advertisement and its visually similar advertisements can be similar in many aspects in terms of visual content, but there still can be differences between the advertisement and the visually similar advertisements. The difference determination module 204 can identify such differences between the advertisement and the visually similar advertisements.

As mentioned above, each advertisement can be described by a representation and, in some embodiments, the representation can include a set of features. Some or all of features in representations of advertisements can relate to visual content of the advertisements and indicate various types of information. For instance, features can indicate whether an advertisement includes certain elements, such as objects, animals, people (e.g., faces), concepts, themes, subject matters, etc. Details relating to elements can also be available, for example, as features. As an example, one or more features can indicate whether an advertisement depicts a particular object or type of object. Details relating to an object can include information about a size of the object, a color of the object, a perspective or angle of the object (e.g., front facing, rotated, etc.), a shape of the object, etc. As another example, features can indicate whether an advertisement depicts people (e.g., faces) and/or a number of people (e.g., faces) depicted in the advertisement. Details relating to a person can include information about a gender of the person, an age or age range of the person, an expression of the person, etc. As a further example, features can indicate whether an advertisement depicts nature, such as mountains, oceans, etc. Many variations are possible.

The difference determination module 204 can determine differences between visual content of an advertisement and visual content of similar advertisements based on their respective representations. Since the advertisement and the visually similar advertisements are associated with the same cluster, they are likely to have the same or similar values for many features. Accordingly, in some instances, the difference determination module 204 can identify features for which the advertisement and the visually similar advertisements do not have the same or similar values. In some embodiments, values for features may be considered to be similar if they satisfy a threshold value or range, and values for features may be considered to be different if they do not satisfy a threshold value or range. In other embodiments, values for features may be considered to be similar if a difference between the values satisfies a threshold value or range, and values for features may be considered to be different if a difference between the values does not satisfy a threshold value or range. Many variations are possible.

The difference determination module 204 can identify differences between visual content of advertisements based on features that have different values. As an example, a difference between two advertisements can be presence or absence of one or more elements. For instance, one advertisement may include one or more objects that do not appear in the other advertisement. As another example, a difference can be in arrangement and/or locations of elements. For instance, two advertisements may include the same objects or same types of objects, but a placement of the objects may differ between the two advertisements. As a further example, a difference can relate to characteristics of elements. For instance, two advertisements may include the same objects or same types of objects, but characteristics of the objects, such as color, size, lighting, etc. can differ between the advertisements. Many variations are possible. Recommendations for improving qualitative ratings can be generated based on identified differences between an advertisement and its visually similar advertisements, for example, by the recommendation generation module 208, as described below.

The template determination module 206 can provide one or more templates associated with improving qualitative ratings of an advertisement. A template can provide visualization of arrangement of elements for an advertisement. For example, a template can indicate elements to include, a specific arrangement or layout of elements, specific characteristics of elements, etc. In some cases, visually similar advertisements for an advertisement can be provided with recommendations. However, in other cases, visually similar advertisements may not be provided with recommendations, for example, because the visually similar advertisements are confidential. In such cases, the template determination 206 can determine one or more templates that are visually similar to the advertisement and/or the visually similar advertisements, and provide the templates with recommendations. For example, templates can be helpful in visualizing how to implement recommendations. In some embodiments, templates for the advertisement can be determined based on machine learning techniques. For example, a machine learning model can be trained to determine templates based on training data (e.g., labeled data) that includes representations of advertisements and corresponding templates.

The recommendation generation module 208 can generate recommendations for improving qualitative ratings of an advertisement. For example, the recommendation generation module 208 can generate recommendations for an advertisement with predicted low values of qualitative ratings based on differences between the advertisement and its visually similar advertisements having high values of qualitative ratings. The recommendation generation module 208 can generate one or more recommendations based on differences between the advertisement and the visually similar advertisements. For example, the recommendation generation module 208 can generate a recommendation for each difference or multiple differences. In certain embodiments, the recommendation generation module 208 can also indicate a qualitative rating to which a recommendation relates. As an example, an advertisement may have a low value for the noticeability qualitative rating. The advertisement and its visually similar advertisements can depict an outdoor scene, such as a park. An identified difference between the advertisement and the visually similar advertisements can be that the advertisement does not depict people. The recommendation generation module 208 can generate a recommendation to include one or more people in the advertisement. The recommendation generation module 208 can also indicate that the recommendation relates to the noticeability qualitative rating. In some embodiments, the recommendation generation module 208 can also provide one or more templates, for example, as determined by the template determination module 206, as described above. In the example above, a template determined for the advertisement can depict an outdoor scene and can provide a visualization of arrangement of elements within the outdoor scene. In some instances, the recommendation generation module 208 can also provide recommendations based on templates. For example, a recommendation can relate to a difference between the advertisement and a template. In certain embodiments, recommendations for improving qualitative ratings can be provided even if predicted values of qualitative ratings for the advertisement are high, for example, based on visually similar advertisements that have even higher values of qualitative ratings compared to the advertisement.

The application workflow module 210 can provide workflows for providing recommendations for improving qualitative ratings of advertisements via one or more applications. A workflow for providing recommendations can be provided in various applications. For example, an application (or “app”) can run on a computing device of a user or administrator responsible for optimizing an advertisement. In some embodiments, applications can be associated a social networking system. Examples of applications can include a chat or messaging application, a pages manager application, a social networking application, etc. Many variations are possible. A workflow for providing recommendations can be based on various steps or a sequence of tasks through which recommendations can be provided. For example, the workflow can allow a user to upload an advertisement or capture an image of an advertisement. After an advertisement or an image of an advertisement is obtained, the workflow can determine a representation (e.g., a set of features) for the advertisement and determine qualitative ratings for the advertisement based on the representation. The workflow can provide predicted qualitative ratings to the user. If predicted values of qualitative ratings for the advertisement are low, the workflow can provide recommendations for improving qualitative ratings to the user. The workflow can be supported by various modules of the advertisement recommendation module 102, as discussed herein.

In some embodiments, recommendations for improving qualitative ratings of advertisements can be provided by a chat or messaging application. In certain embodiments, a workflow for providing recommendations can be implemented based on a bot or other automated agents. For instance, the workflow can be implemented as a conversation between the bot and the user. As an example, a bot can ask a user to upload an advertisement or capture an image of an advertisement. After the user provides the advertisement, the bot can provide predicted qualitative ratings for the advertisement. If values for any of the qualitative ratings for the advertisement are low, the bot may ask the user whether the user would like to see recommendations for improving the qualitative ratings. If the user chooses to see the recommendations, the bot can provide the recommendations and/or relevant templates. In some embodiments, the bot can automatically provide recommendations for improving the qualitative ratings without asking the user whether the user would like see the recommendations.

In certain embodiments, recommendations for improving qualitative ratings of advertisements can be provided by a pages manager application. In some embodiments, a pages manager app can be used by administrators to manage pages representing entities on a social networking system. A workflow for providing recommendations can be provided in the pages manager app. For example, an administrator can select a user interface (UI) element (e.g., a button, an icon, a link, etc.) in order to access the workflow. Steps of the workflow can be the same as or similar to steps described above. All examples herein are provided for illustrative purposes, and there can be many variations and other possibilities.

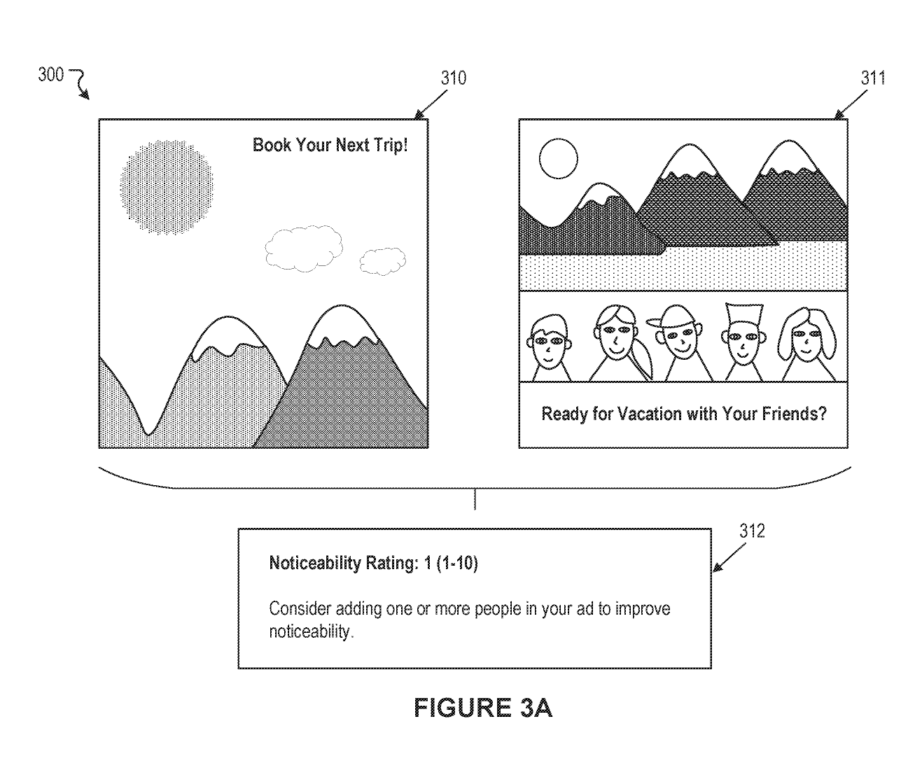

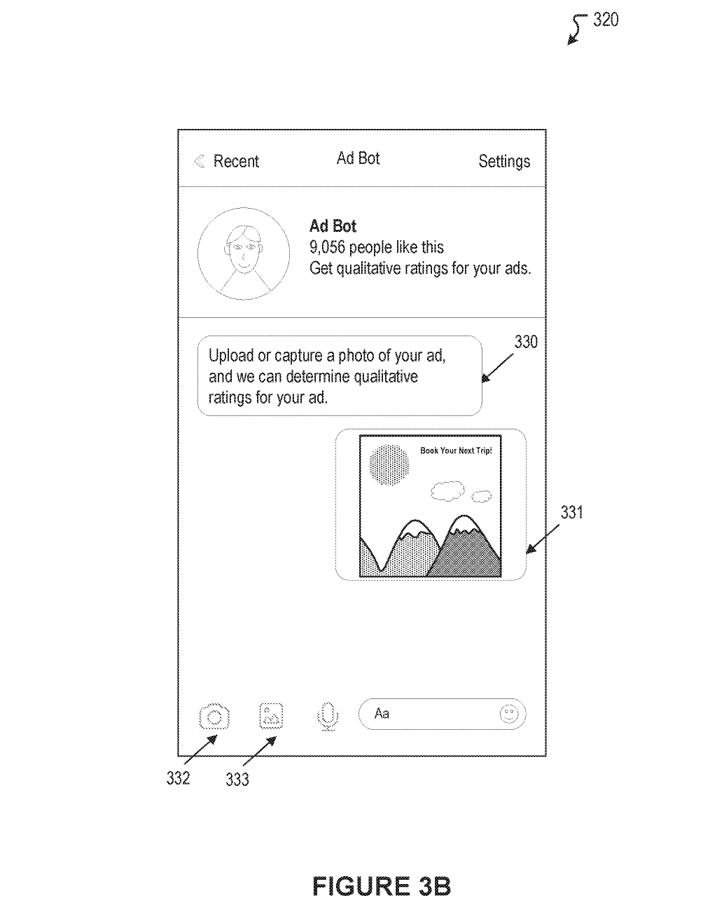

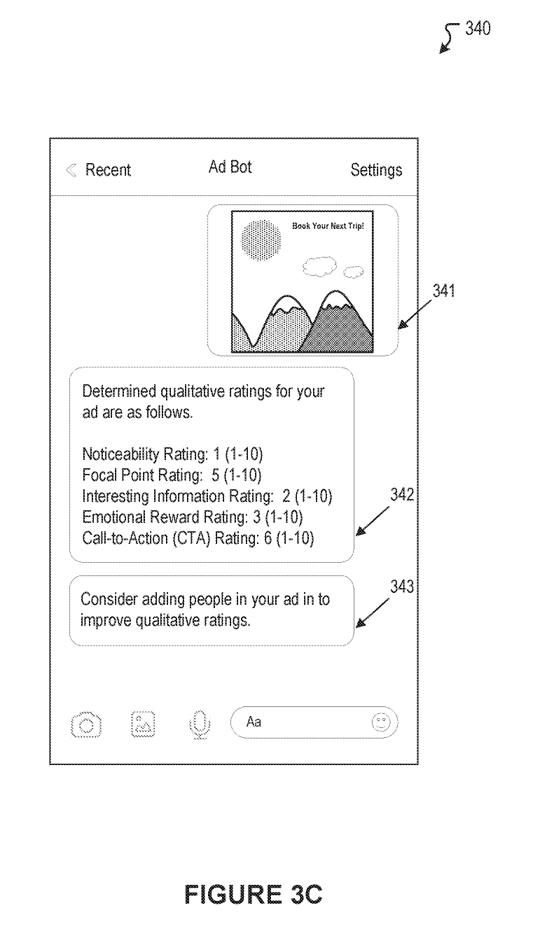

FIG. 3A illustrates an example scenario 300 for providing recommendations for improving qualitative ratings of advertisements, according to an embodiment of the present disclosure. In the example scenario 300, an advertisement 310 is submitted for a prediction of qualitative ratings associated with the advertisement 310. As an example, a predicted value of a noticeability qualitative rating for the advertisement 310 may be low (e.g., does not satisfy a threshold value). For instance, the value is 1 out of a scale of 1 to 10. An advertisement 311 that is visually similar to the advertisement 310 can be identified based on respective representations of the advertisement 310 and the advertisement 311. For example, the advertisement 311 can be identified by the advertisement recommendation module 102 as described above. The advertisement 311 can be identified based on a set of features (e.g., a feature vector) and clustering in a related feature space. The advertisement 311 can have a higher value of the noticeability qualitative rating than the advertisement 310. In the example scenario 300, the advertisement 310 and the advertisement 311 both depict an outdoor scene including mountains. Differences between the advertisement 310 and the advertisement 311 can be identified in order to provide recommendations for improving the noticeability qualitative rating of the advertisement 310. For example, differences between the advertisement 310 and the advertisement 311 can be determined by the advertisement recommendation module 102 as described above. For instance, features of the advertisement 310 and the features of the advertisement 311 can be compared to identify features for which the advertisement 310 and the advertisement 311 have different values. In the example scenario 300, at least one difference between the advertisement 310 and the advertisement 311 is that the advertisement 311 includes one or more people. Accordingly, a recommendation 312 can be provided to a user that submitted the advertisement 310 to consider including one or more people in the advertisement 310. The recommendation 312 can also indicate that the recommendation 312 relates to the noticeability qualitative rating. All examples herein are provided for illustrative purposes, and there can be many variations and other possibilities.

FIGS. 3B-3C illustrate example user interfaces 320, 340 for providing recommendations for improving qualitative ratings of advertisements, according to an embodiment of the present disclosure. Qualitative ratings and recommendations can be provided by the advertisement recommendation module 102 as described above. In the example of FIGS. 3B and 3C, the user interface 320 and the user interface 340 are associated with and generated by a chat or messaging application. The user interface 320 and the user interface 340 illustrate a chat conversation between a bot and a user. In the example of FIG. 3B, the bot sends a message 330 for the user to upload an advertisement or capture a photo of an advertisement. For example, the message 330 can be displayed to the user in response to the user accessing or initiating a chat conversation with the bot. In the example of FIG. 3B, the user may capture a photo of an advertisement by selecting an icon 332 or upload a photo of an advertisement by selecting an icon 333. In some embodiments, the user can upload a file for an advertisement. Many variations are possible. A message 331 shows a preview or a smaller version of an advertisement that has been submitted by the user. In the example of FIG. 3C, the message 341 is the same as the message 331 in FIG. 3B. After receiving the advertisement from the user, the bot provides qualitative ratings for the advertisement in a message 342. For example, a value for each qualitative rating is listed with a scale on which the value was determined. As an example, the noticeability qualitative rating has a value of 1, which is on a scale of 1 to 10. The bot provides a recommendation for improving the qualitative ratings for the advertisement in a message 343. All examples herein are provided for illustrative purposes, and there can be many variations and other possibilities.

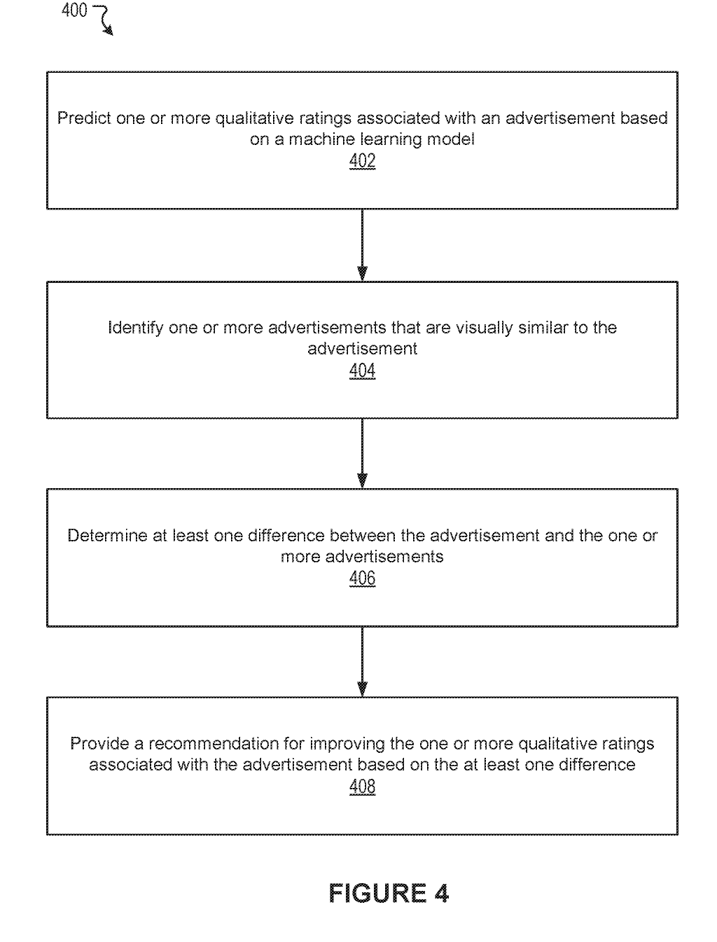

FIG. 4 illustrates an example first method 400 for providing recommendations for improving qualitative ratings of advertisements, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can predict one or more qualitative ratings associated with an advertisement based on a machine learning model. At block 404, the example method 400 can identify one or more advertisements that are visually similar to the advertisement. At block 406, the example method 400 can determine at least one difference between the advertisement and the one or more advertisements. At block 408, the example method 400 can provide a recommendation for improving the one or more qualitative ratings associated with the advertisement based on the at least one difference. Other suitable techniques that incorporate various features and embodiments of the present disclosure are possible.

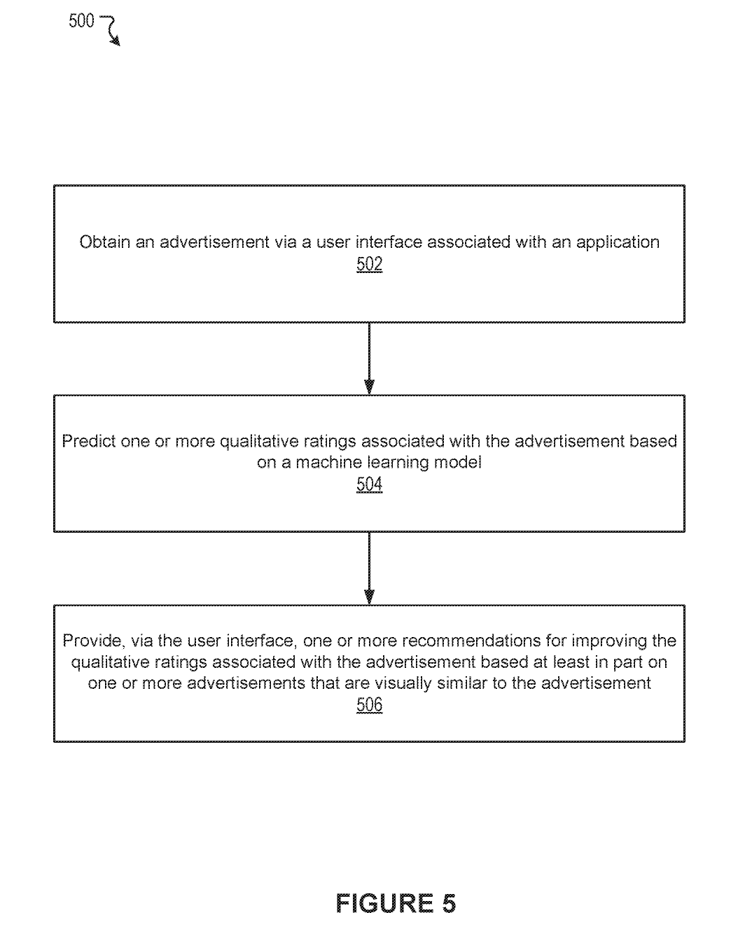

FIG. 5 illustrates an example second method 500 for providing recommendations for improving qualitative ratings of advertisements, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can obtain an advertisement via a user interface associated with an application. At block 504, the example method 500 can predict one or more qualitative ratings associated with the advertisement based on a machine learning model. At block 506, the example method 500 can provide, via the user interface, one or more recommendations for improving the qualitative ratings associated with the advertisement based at least in part on one or more advertisements that are visually similar to the advertisement. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an advertisement recommendation module 646. The advertisement recommendation module 646 can be implemented with the advertisement recommendation module 102, as discussed in more detail herein. In some embodiments, one or more functionalities of the advertisement recommendation module 646 can be implemented in the user device 610.

### Hardware Implementation

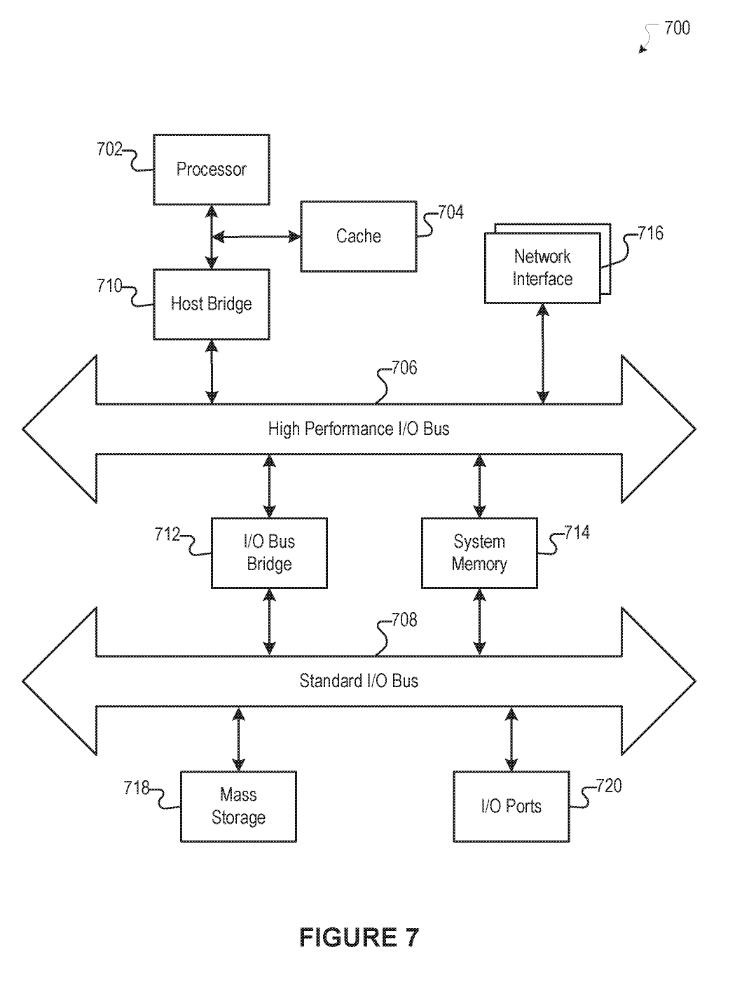

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
predicting, by a computing system, one or more qualitative ratings associated with an advertisement based on a machine learning model;
identifying, by the computing system, one or more advertisements that are visually similar to the advertisement;
determining, by the computing system, at least one difference between the advertisement and the one or more advertisements; and
providing, by the computing system, a recommendation for improving the one or more qualitative ratings associated with the advertisement based on the at least one difference.

2. The computer-implemented method of claim 1, wherein a representation of each advertisement includes a feature vector including a set of features.

3. The computer-implemented method of claim 2, wherein the determining the at least one difference between the advertisement and the one or more advertisements includes identifying one or more features in the set of features for which values associated with the advertisement and values associated with the one or more advertisements are different.

4. The computer-implemented method of claim 3, wherein a difference between the values associated with the advertisement and the values associated with the one or more advertisements satisfies one or more of a threshold value or a threshold range.

5. The computer-implemented method of claim 3, wherein the recommendation for improving the one or more qualitative ratings is based on the identified one or more features.

6. The computer-implemented method of claim 1, wherein the at least one difference relates to one or more of: presence of an element, absence of an element, an arrangement of one or more elements, or characteristics associated with one or more elements.

7. The computer-implemented method of claim 1, wherein the one or more qualitative ratings relate to one or more of: noticeability, a focal point, interesting information, an emotional reward, or a call-to-action (CTA).

8. The computer-implemented method of claim 1, further comprising determining a template for the advertisement, wherein the template is visually similar to the advertisement.

9. The computer-implemented method of claim 1, wherein values of qualitative ratings associated with the one or more advertisements are higher than values of the one or more qualitative ratings associated with the advertisement.

10. The computer-implemented method of claim 1, wherein the one or more advertisements are associated with a cluster of advertisements with which the advertisement is associated.

11. A system comprising:
at least one hardware processor; and
a memory storing instructions that, when executed by the at least one processor, cause the system to perform:
predicting one or more qualitative ratings associated with an advertisement based on a machine learning model;
identifying one or more advertisements that are visually similar to the advertisement;
determining at least one difference between the advertisement and the one or more advertisements; and
providing a recommendation for improving the one or more qualitative ratings associated with the advertisement based on the at least one difference.

12. The system of claim 11, wherein a representation of each advertisement includes a feature vector including a set of features.

13. The system of claim 12, wherein the determining the at least one difference between the advertisement and the one or more advertisements includes identifying one or more features in the set of features for which values associated with the advertisement and values associated with the one or more advertisements are different.

14. The system of claim 13, wherein the recommendation for improving the one or more qualitative ratings is based on the identified one or more features.

15. The system of claim 11, wherein the at least one difference relates to one or more of: presence of an element, absence of an element, an arrangement of one or more elements, or characteristics associated with one or more elements.

16. A non-transitory computer readable medium including instructions that, when executed by at least one hardware processor of a computing system, cause the computing system to perform a method comprising:
predicting one or more qualitative ratings associated with an advertisement based on a machine learning model;
identifying one or more advertisements that are visually similar to the advertisement;
determining at least one difference between the advertisement and the one or more advertisements; and
providing a recommendation for improving the one or more qualitative ratings associated with the advertisement based on the at least one difference.

17. The non-transitory computer readable medium of claim 16, wherein a representation of each advertisement includes a feature vector including a set of features.

18. The non-transitory computer readable medium of claim 17, wherein the determining the at least one difference between the advertisement and the one or more advertisements includes identifying one or more features in the set of features for which values associated with the advertisement and values associated with the one or more advertisements are different.

19. The non-transitory computer readable medium of claim 18, wherein the recommendation for improving the one or more qualitative ratings is based on the identified one or more features.

20. The non-transitory computer readable medium of claim 16, wherein the at least one difference relates to one or more of: presence of an element, absence of an element, an arrangement of one or more elements, or characteristics associated with one or more elements.
